(19) United States
(12) Patent Application Publication
(10) Pub. No.: US 2024/0317088 A1
(43) Pub. Date: Sep. 26, 2024

(54) VEHICLE AND METHOD FOR CONTROLLING VEHICLE

(71) Applicant: KABUSHIKI KAISHA TOYOTA JIDOSHOKKI, Aichi-ken (JP)

(72) Inventor: Takahiro SUZUKI, Kariya-shi (JP)

(73) Assignee: KABUSHIKI KAISHA TOYOTA JIDOSHOKKI, Aichi-ken (JP)

(21) Appl. No.: 18/599,927

(22) Filed: Mar. 8, 2024

(30) Foreign Application Priority Data
Mar. 23, 2023 (JP) 2023-046222

(51) Int. Cl. B60L 53/22; B60K 11/02; B60L 53/122

(52) U.S. Cl. CPC B60L 53/22; B60K 11/02; B60L 53/122; B60L 2210/30

(57) ABSTRACT

A vehicle includes a battery, a coil, a metal body located at a position that is affected by a magnetic field generated in the coil, a charger configured to convert alternating-current power supplied from outside the vehicle into direct-current power and supply the direct-current power to the battery, and processing circuitry configured to control the charger. The charger is configured to receive supply of direct-current power from the battery. The processing circuitry is further configured to control the charger so that the charger modulates the direct-current power, which is supplied from the battery, over time and supplies the power to the coil.

### BACKGROUND

### 1. Field

The present disclosure relates to a vehicle and a method for controlling a vehicle.

### 2. Description of Related Art

Japanese Laid-Open Patent Publication No. 2019-122210 describes a charger that converts power from an external power supply and supplies the converted power to a battery.

The charger described in the above publication is used to charge the battery when the vehicle is stopped. However, the battery charger is not used when the vehicle is traveling.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a vehicle includes a battery, a coil, a metal body located at a position that is affected by a magnetic field generated in the coil, a charger configured to convert alternating-current power supplied from outside the vehicle into direct-current power and supply the direct-current power to the battery, and processing circuitry configured to control the charger. The charger is configured to receive supply of direct-current power from the battery. The processing circuitry is further configured to control the charger so that the charger modulates the direct-current power, which is supplied from the battery, over time and supplies the power to the coil.

In another general aspect, a method for controlling a vehicle is provided. The vehicle includes a battery, a coil, a metal body located at a position that is affected by a magnetic field generated in the coil, and a charger configured to convert alternating-current power supplied from outside the vehicle into direct-current power and supply the direct-current power to the battery. The method includes causing the charger to receive supply of direct-current power from the battery, and causing the charger to modulate the direct-current power, which is supplied from the battery, over time and supply the power to the coil.

Other features and aspects will be apparent from the following detailed description, the drawings, and the claims.

### BRIEF DESCRIPTION OF THE DRAWINGS

FIG. 1 is a block diagram illustrating a vehicle according to one embodiment.

FIG. 2 is a schematic diagram of a circulation mechanism of the vehicle in FIG. 1.

FIG. 3 is a circuit diagram of a charger included in the vehicle in FIG. 1.

FIG. 4 is a circuit diagram showing a modified example of the charger.

FIG. 5 is a circuit diagram showing another modified example of the charger that is different from that shown in FIG. 4.

FIG. 6 is a circuit diagram showing another modified example of the charger that is different from those shown in FIGS. 4 and 5.

FIG. 7 is a circuit diagram showing another modified example of the charger that is different from those shown in FIGS. 4, 5, and 6.

FIG. 8 is a circuit diagram showing another modified example of the charger that is different from those shown in FIGS. 4, 5, 6, and 7.

FIG. 9 is a circuit diagram showing another modified example of the charger that is different from those shown in FIGS. 4, 5, 6, 7, and 8.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A vehicle and a method for controlling a vehicle according to one embodiment will now be described with reference to the drawings. The vehicle includes vehicles driven by electric motors such as battery electric vehicles (BEVs), plug-in hybrid electric vehicles (PHEVs), and plug-in fuel cell electric vehicles (PFCEVs). The vehicle is charged when supplied with external power.

### Vehicle

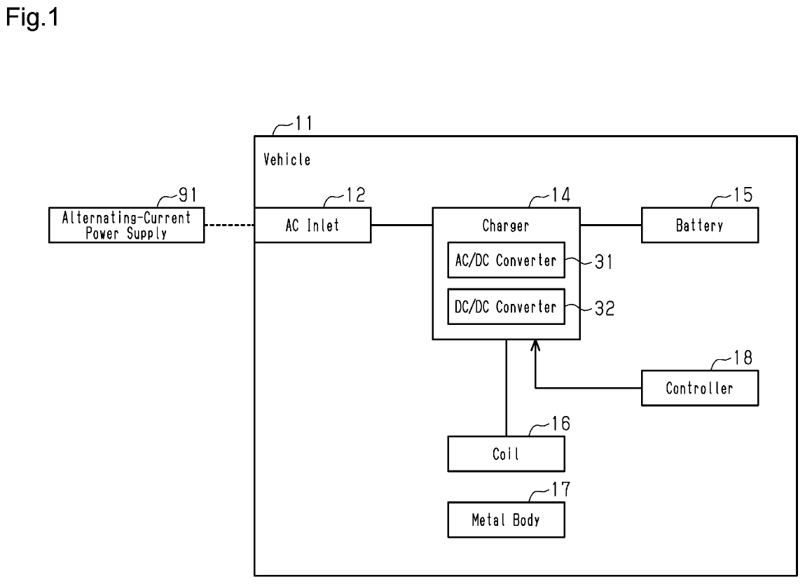

As shown in FIG. 1, a vehicle 11 includes an alternating-current (AC) inlet 12, a charger 14, a battery 15, a coil 16, a metal body 17, and a controller 18. Alternating-current power from the outside of the vehicle 11 is supplied to the vehicle 11 through the AC inlet 12.

The AC inlet 12 is connectable to, for example, an alternating-current power supply 91 of a single-phase or three-phase. When the AC inlet 12 is connected to the alternating-current power supply 91, alternating-current power is supplied to the vehicle 11.

The charger 14 is connected to the AC inlet 12. The charger 14 includes an AC/DC converter 31 and a DC/DC converter 32. The AC/DC converter 31 converts alternating-current power, which is supplied from the outside through the AC inlet 12, into direct-current power. The DC/DC converter 32 converts direct-current power output from the AC/DC converter 31 into direct-current power having a different voltage and supplies the converted direct-current power to the battery 15.

The charger 14 can also convert direct-current power, which is supplied from the battery 15, into alternating-current power. The charger 14 can supply the converted alternating-current power to the coil 16 or the outside of the vehicle 11 through the AC inlet 12. That is, the charger 14 modulates the direct-current power, which is supplied from the battery 15, over time and supplies the power to the coil 16. The charger 14 will be described in detail below.

The battery 15 is charged when receiving direct-current power. The battery 15 is, for example, a rechargeable battery, an electric double-layer capacitor, or the like. The battery 15 is connected to the charger 14. The battery 15 is supplied with direct-current power converted by the charger 14. The battery 15 discharges to supply direct-current power to the charger 14.

The coil 16 is connected to the charger 14. The coil 16 is supplied with alternating-current power converted by the charger 14. When the coil 16 is supplied with alternating-current power, the current flowing through the coil 16 is changed. This changes the magnetic field generated in the coil 16.

The metal body 17 is a member made of metal. The metal body 17 is located at a position that is affected by the magnetic field generated in the coil 16. When the magnetic field affecting the metal body 17 is changed, an eddy current flows in the metal body 17. When the eddy current flows in the metal body 17, the metal body 17 generates heat due to Joule heat. In this manner, the metal body 17 is inductively heated with the coil 16. Thus, the coil 16 is used as a heater heating the metal body 17. The coil 16 is electrically insulated from the metal body 17 so as to safely heat the metal body 17.

The heat generation of the metal body 17 in the vehicle 11 can heat various types of components. In one example, the heat generation of the metal body 17 heats the battery 15. This stabilizes the charging performance and the discharging performance of the battery 15. The heat generation of the metal body 17 may heat seats, the vehicle space, and the steering device in addition to the battery 15. For example, the metal body 17 may be embedded in the seats, arranged inside the air conditioner unit, or installed in the steering device.

The controller 18 controls the charger 14. Specifically, the controller 18 controls multiple switching elements included in the charger 14. More specifically, the controller 18 controls switching elements of the AC/DC converter 31 and switching elements of the DC/DC converter 32. Thus, the controller 18 converts alternating-current power into direct-current power with the charger 14 and converts direct-current power into alternating-current power with the charger 14.

The controller 18, serving as processing circuitry, may include one or more processors that execute various types of processes according to a computer program. The controller 18 may be configured with one or more dedicated hardware circuits such as an application-specific integrated circuit that executes at least part of various types of processes. The controller 18 may also be configured as circuitry including a combination of a processor and a hardware circuit. The processor includes a CPU and memory such as RAM and ROM. The memory stores program code or instructions configured to cause the CPU to execute processes. The memory, or computer readable media, includes any type of media that is accessible by versatile computers or dedicated computers.

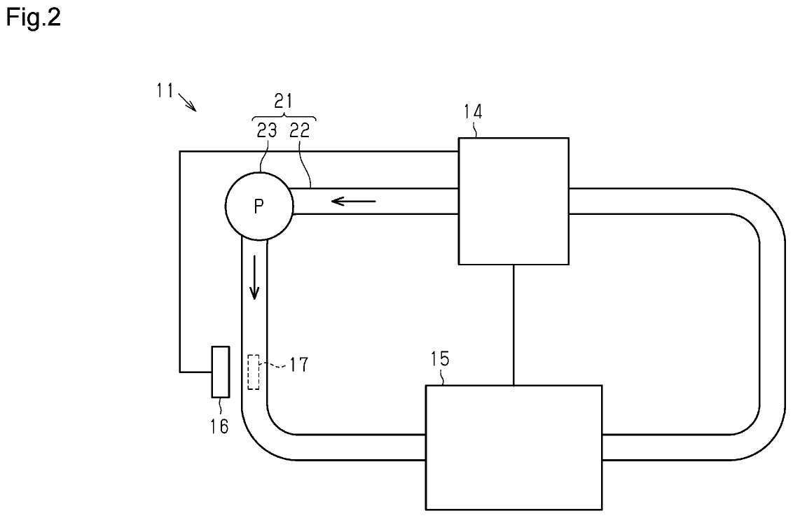

As shown in FIG. 2, the vehicle 11 includes a circulation mechanism 21. The circulation mechanism 21 is a mechanism that circulates fluid. The circulation mechanism 21 circulates the fluid to adjust the temperature of the battery 15. The fluid may be liquid, gas, or a mixture of liquid and gas. In one example, the fluid is coolant. Thus, the circulation mechanism 21 circulates the coolant.

The circulation mechanism 21 includes a fluid pipe 22 and a pump 23.

The fluid pipe 22 is a pipe through which fluid circulates. The fluid pipe 22 extends in a looped shape. Fluid flows through the fluid pipe 22. The fluid pipe 22 extends so that the fluid exchanges heat with the battery 15. In one example, the fluid pipe 22 is in direct contact with the battery 15. The fluid pipe 22 may be in contact with the battery 15 through, for example, a heat exchanger.

The pump 23 is arranged in the fluid pipe 22. The pump 23 sends fluid in one direction through the fluid pipe 22. In one example, the pump 23 sends the fluid in a direction indicated by the arrows in FIG. 2. This circulates the fluid through the fluid pipe 22.

The circulation mechanism 21 heats the battery 15 by transferring heat generated from the metal body 17 to the battery 15. Specifically, the circulation mechanism 21 heats the battery 15 by circulating the fluid heated by the metal body 17.

The metal body 17 is arranged inside the fluid pipe 22. Thus, the fluid flowing through the fluid pipe 22 is in contact with the metal body 17 and the fluid is effectively heated.

The metal body 17 is located downstream from the pump 23 and upstream from the battery 15 in a direction in which the pump 23 circulates the fluid. In this manner, the fluid heated by the metal body 17 immediately reaches the battery 15 so as to easily heat the battery 15.

The metal body 17 does not need to be arranged inside the fluid pipe 22. Instead, the metal body 17 may, for example, form part of the fluid pipe 22 or be a metal case covering the fluid pipe 22. In this case, the fluid pipe 22, when heated, heats the fluid.

The fluid pipe 22 may extend so that the fluid exchanges heat with the charger 14. In one example, the fluid pipe 22 is in direct contact with the charger 14. The fluid pipe 22 may be in contact with the charger 14 through, for example, a heat exchanger. The charger 14 generates heat when converting power. Specifically, the charger 14 generates heat when supplying power to the coil 16. Thus, when the fluid pipe 22 extends through the charger 14, heat generated by the charger 14 heats the fluid. In this case, thermal efficiency is improved as compared with a case where the fluid is heated only by the coil 16. In addition, since the fluid pipe 22 extends through the charger 14, the charger 14 is cooled.

The fluid pipe 22 may extend so that the fluid exchanges heat with a radiator. In this case, the heat of the fluid is externally released through the radiator so as to easily adjust the temperature of the battery 15.

The fluid pipe 22 may extend through an air conditioning unit. In this case, for example, heated fluid heats air blown out from the air conditioning unit. This heats the passenger compartment space. In this manner, when the metal body 17 heats the fluid flowing through the fluid pipe 22, various types of components are more easily heated by the heated fluid than when the metal body 17 is directly attached to each of heating subjects.

### Charger

An example of the charger 14 will now be described.

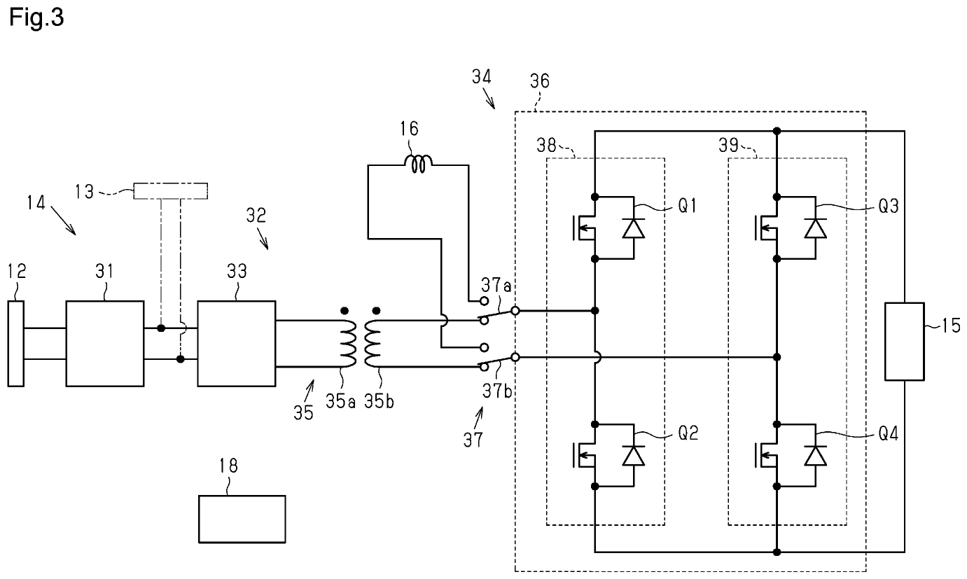

As shown in FIG. 3, the charger 14 includes the AC/DC converter 31 and the DC/DC converter 32.

The AC/DC converter 31 is connected to the AC inlet 12. The AC/DC converter 31 performs AC/DC conversion that converts alternating-current power supplied from the AC inlet 12 into direct-current power. AC/DC converter 31 is connected to DC/DC converter 32. The AC/DC converter 31 supplies the converted direct-current power to the DC/DC converter 32. The AC/DC converter 31 may convert direct-current power supplied from the DC/DC converter 32 into alternating-current power and supply the alternating-current power to the alternating-current power supply 91 through the AC inlet 12.

The DC/DC converter 32 includes a primary circuit 33 and a secondary circuit 34. The primary circuit 33 and the secondary circuit 34 are electrically connected to each other through a transformer 35 that includes a primary winding 35a and a secondary winding 35b. The secondary circuit 34 will now be described in detail.

The secondary circuit 34 includes an output switching unit 37 and a switching unit 36 including multiple switching elements.

In one example, the switching unit 36 includes a first upper arm switching element Q1, a first lower arm switching element Q2, a second upper arm switching element Q3, and a second lower arm switching element Q4. The switching elements each have a body diode. The switching elements are semiconductor switching elements, for example, metal-oxide-semiconductor field-effect transistors, insulated gate bipolar transistors, gallium nitride high electron mobility transistors (GanHEMTs), or the like.

The switching unit 36 is a bridge circuit. The switching unit 36 includes a first leg 38 and a second leg 39. The first leg 38 is a series connection in which the first upper arm switching element Q1 and the first lower arm switching element Q2 are connected in series to each other. The second leg 39 is a series connection in which the second upper arm switching element Q3 and the second lower arm switching element Q4 are connected in series to each other.

A connection node of the first upper arm switching element Q1 and the second upper arm switching element Q3 is connected to a first end of the battery 15. A connection node of the first lower arm switching element Q2 and the second lower arm switching element Q4 is connected to a second end of the battery 15.

The output switching unit 37 includes a first switch 37a and a second switch 37b. The first switch 37a includes a first end that is connected to a connection node of the first upper arm switching element Q1 and the first lower arm switching element Q2. The first switch 37a includes a second end that is selectively connected to a first end of the secondary winding 35b or a first end of the coil 16. The second switch 37b includes a first end that is connected to a connection node of the second upper arm switching element Q3 and the second lower arm switching element Q4. The second switch 37b includes a second end that is selectively connected to a second end of the secondary winding 35b or a second end of the coil 16.

The output switching unit 37 is controlled by the controller 18. The output switching unit 37 switches connection of the switching unit 36 between the secondary winding 35b and the coil 16. When the output switching unit 37 connects the switching unit 36 to the secondary winding 35b, the switching unit 36 is disconnected from the coil 16. When the output switching unit 37 connects the switching unit 36 to the coil 16, the switching unit 36 is disconnected from the secondary winding 35b.

### Switching Operation

A switching operation of the charger 14 performed by the controller 18, specifically, a switching operation of the secondary circuit 34 will now be described.

When power is supplied from the alternating-current power supply 91 to the vehicle 11 through the AC inlet 12, the charger 14 converts power for charging. The controller 18 controls the switching elements of the charger 14 to convert the alternating-current power, which is supplied from the alternating-current power supply 91, into direct-current power and charge the battery 15.

Further, the controller 18 controls the charger 14 to modulate the direct-current power, which is supplied from the battery 15 to the charger 14, over time and supply the power to the coil 16. In other words, the controller 18 controls the charger 14 to convert the direct-current power, which is supplied from the battery 15 to the charger 14, into power having magnitude and/or a direction of current and/or voltage that change over time and supply the converted power to the coil 16. In one example, during traveling, the controller 18 supplies alternating-current power to the coil 16 by controlling the first upper arm switching element Q1, the first lower arm switching element Q2, the second upper arm switching element Q3, and the second lower arm switching element Q4. For example, the controller 18 alternately turns ON/OFF a group of the first upper arm switching element Q1 and the second lower arm switching element Q4 and a group of the first lower arm switching element Q2 and the second upper arm switching element Q3. Specifically, the controller 18 alternately switches between a state in which the first upper arm switching element Q1 and the second lower arm switching element Q4 are ON and the first lower arm switching element Q2 and the second upper arm switching element Q3 are OFF and a state in which the first upper arm switching element Q1 and the second lower arm switching element Q4 are OFF and the first lower arm switching element Q2 and the second upper arm switching element Q3 are ON. In this manner, the controller 18 converts the direct-current power, which is supplied from the battery 15 to the charger 14, into alternating-current power. The controller 18 supplies the converted alternating-current power to the coil 16. The alternating-current power is power that is modulated over time. This changes the magnetic field generated in the coil 16, and the metal body 17 is inductively heated.

The controller 18 controls the amount of current flowing through the coil 16 by controlling the ON/OFF intervals, that is, the switching cycles of the switching elements. Thus, the controller 18 adjusts the heating temperature of the metal body 17 with the coil 16. The controller 18 adjusts the temperature of the battery 15 by controlling the switching elements. The controller 18 may control the switching elements based on an output value of a temperature sensor that detects the temperature of the battery 15. The controller 18 may have a dead time during switching.

The controller 18 controls induction heating with the coil 16 by operating the switching elements of the charger 14. Thus, the vehicle 11 does not need to include a separate element that controls the induction heating with the coil 16. Thus, the battery 15 is heated while limiting the complication of the configuration of the vehicle 11.

### Operation and Advantages of Present Embodiment

The operation and advantage of the above-described embodiment will now be described.

(1) The controller 18 modulates direct-current power, which is supplied from the battery 15, over time and supplies the power to the coil 16 by controlling the charger 14.

When the controller 18 controls the charger 14 to supply the coil 16 with power that is modulated over time, the magnetic field generated in the coil 16 is changed. When the changing magnetic field affects the metal body 17, the metal body 17 is inductively heated. That is, the coil 16 is used as a heater. In this manner, with the above configuration, the charger 14 is used even when the vehicle 11 travels. Thus, the charger 14 can be effectively used.

(2) The metal body 17 is arranged to be in contact with the fluid circulating through the fluid pipe 22. With the above configuration, the battery 15 is heated using the fluid flowing through the fluid pipe 22.

(3) The metal body 17 is arranged inside the fluid pipe 22. With the above configuration, the fluid flowing through the fluid pipe 22 is efficiently heated.

(4) The fluid pipe 22 extends so that the fluid exchanges heat with the charger 14. With the above configuration, the battery 15 is heated by the induction heating with the coil 16 and heat generated by the charger 14.

### Modifications

The above-described embodiment can be modified as follows. The above-described embodiment and the following modifications can be combined with each other as long as there is no technical contradiction.

As indicated by the long-dash double-short-dash lines in FIG. 3, the vehicle 11 may include a DC inlet 13. The DC inlet 13 is connected to the charger 14. The DC inlet 13 is connected to, for example, a connection node of the AC/DC converter 31 and the DC/DC converter 32. The charger 14 converts the voltage of the direct-current power supplied through the DC inlet into a different voltage.

When the vehicle 11 includes the DC inlet 13, the output switching unit 37 may be arranged between the primary circuit 33 and the primary winding 35a, and the output switching unit 37 may switch connection of the primary circuit 33 between the primary winding 35a and the coil 16. In this case, the metal body 17 can be heated by power supplied from the DC inlet 13.

The coil 16 may be connected to a capacitor. The capacitor may be connected in parallel or in series with the coil 16.

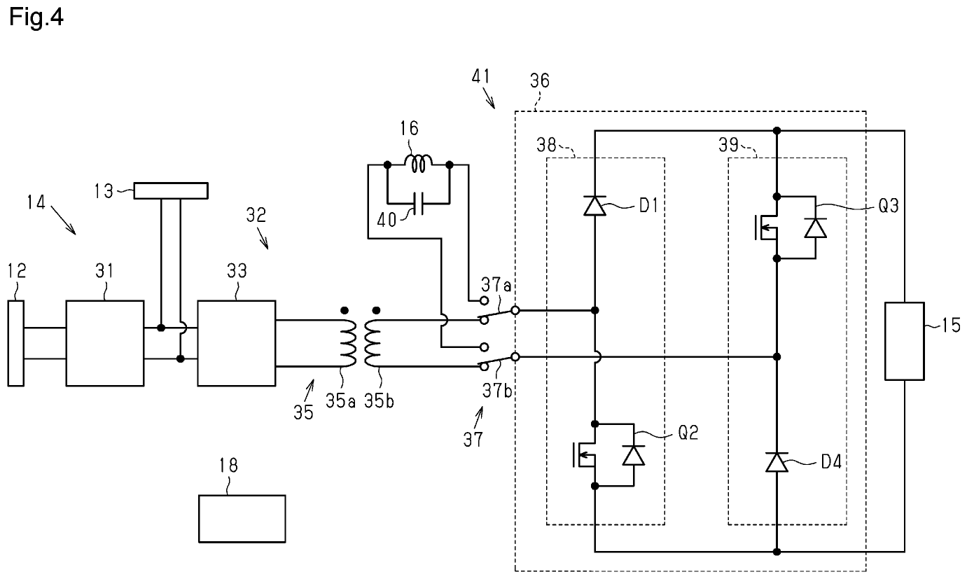

As shown in FIG. 4, the first upper arm switching element Q1 and the second lower arm switching element Q4 of the secondary circuit 34 of the above embodiment may be replaced by diodes. That is, a secondary circuit 41 of this modification includes a first upper diode D1, a first lower arm switching element Q2, a second upper arm switching element Q3, and a second lower diode D4. In this modification, as shown in FIG. 4, the DC inlet 13 may be connected to the charger 14, and the capacitor 40 may be connected to the coil 16.

In the secondary circuit 41, when the battery 15 is charged through the AC inlet 12, the controller 18 turns ON/OFF the switching elements including the first lower arm switching element Q2 and the second upper arm switching element Q3 of the secondary circuit 41. Thus, the controller 18 converts the alternating-current power supplied from the transformer 35 to the secondary circuit 41 into direct-current power and supplies the direct-current power to the battery 15.

During traveling, the controller 18 simultaneously turns ON/OFF the first lower arm switching element Q2 and the second upper arm switching element Q3. That is, the controller 18 controls the charger 14 to modulate the direct-current power, which is supplied from the battery 15 to the charger 14, over time and supply the power to the coil 16. This changes the magnetic field generated in the coil 16.

The controller 18 controls the amount of current flowing through the coil 16 by controlling the switching cycles of the switching elements. Thus, the controller 18 adjusts the heating temperature of the metal body 17 with the coil 16. The controller 18 adjusts the temperature of the battery 15 by controlling the switching elements.

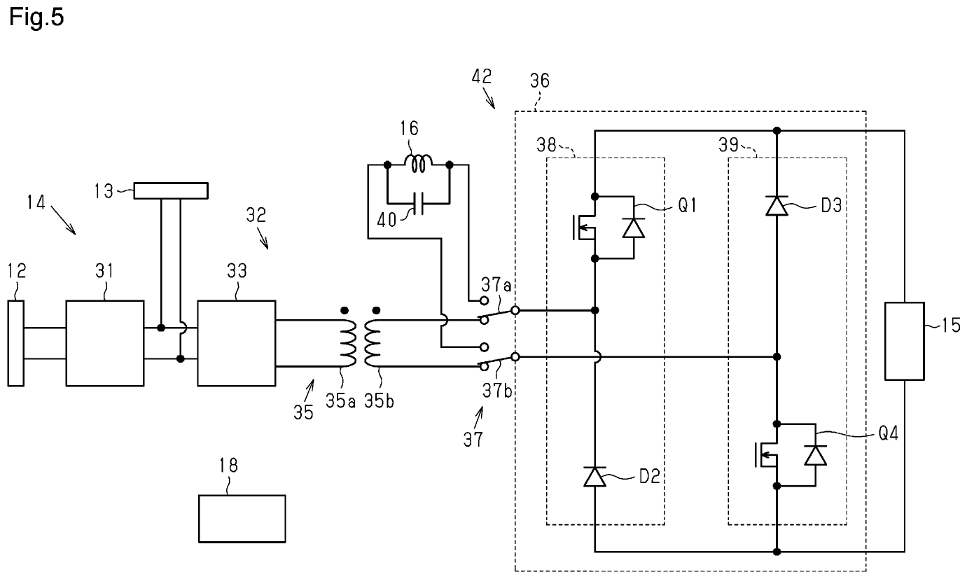

As shown in FIG. 5, the first lower arm switching element Q2 and the second upper arm switching element Q3 of the secondary circuit 34 of the above embodiment may be replaced by diodes. That is, a secondary circuit 42 of this modification includes a first upper arm switching element Q1, a first lower diode D2, a second upper diode D3, and a second lower arm switching element Q4. In this modification, as shown in FIG. 5, the DC inlet 13 may be connected to the charger 14, and the capacitor 40 may be connected to the coil 16.

In the secondary circuit 42, when the battery 15 is charged through the AC inlet 12, the controller 18 turns ON/OFF the switching elements including the first upper arm switching element Q1 and the second lower arm switching element Q4 of the secondary circuit 42. Thus, the controller 18 converts the alternating-current power supplied from the transformer 35 to the secondary circuit 42 into direct-current power and supplies the direct-current power to the battery 15.

During traveling, the controller 18 simultaneously turns ON/OFF the first upper arm switching element Q1 and the second lower arm switching element Q4. That is, the controller 18 controls the charger 14 to modulate the direct-current power, which is supplied from the battery 15 to the charger 14, over time and supply the power to the coil 16. This changes the magnetic field generated in the coil 16.

The controller 18 controls the amount of current flowing through the coil 16 by controlling the switching cycles of the switching elements. Thus, the controller 18 adjusts the heating temperature of the metal body 17 with the coil 16. The controller 18 adjusts the temperature of the battery 15 by controlling the switching elements.

When power is supplied to the coil 16, the controller 18 may perform the same switching operation as the secondary circuit 41 shown in FIG. 4. Specifically, the controller 18 may turn ON/OFF the first lower arm switching element Q2 and the second upper arm switching element Q3 when the first upper arm switching element Q1 and the second lower arm switching element Q4 are OFF. As a result, power is supplied to the coil 16 so that the current flowing through the coil 16 is changed.

When power is supplied to the coil 16, the controller 18 may perform the same switching operation as the secondary circuit 42 shown in FIG. 5. Specifically, the controller 18 may turn ON/OFF the first upper arm switching element Q1 and the second lower arm switching element Q4 when the first lower arm switching element Q2 and the second upper arm switching element Q3 are OFF. As a result, power is supplied to the coil 16 so that the current flowing through the coil 16 is changed.

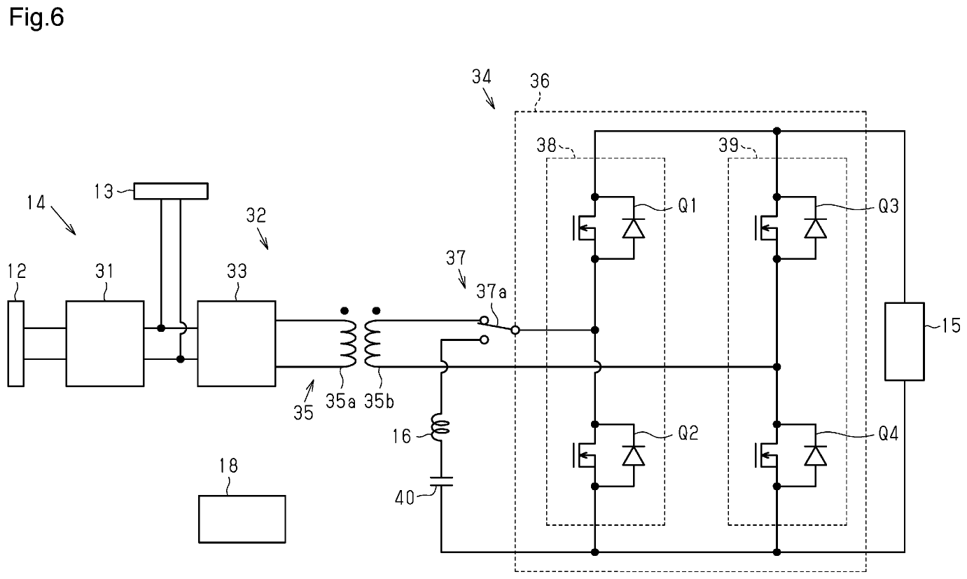

As shown in FIG. 6, the output switching unit 37 may be formed by a single switch. For example, the output switching unit 37 may only include the first switch 37a. The first switch 37a is selectively connected to the first end of the secondary winding 35b or the first end of the coil 16. Thus, the first end of the coil 16 is connectable to the first switch 37a. The second end of the coil 16 is connected to a connection node of the first lower arm switching element Q2 and the second lower arm switching element Q4, that is, the second end of the battery 15. When the first switch 37a is connected to the coil 16, the controller 18 controls induction heating with the coil 16 by controlling the switching elements of the charger 14.

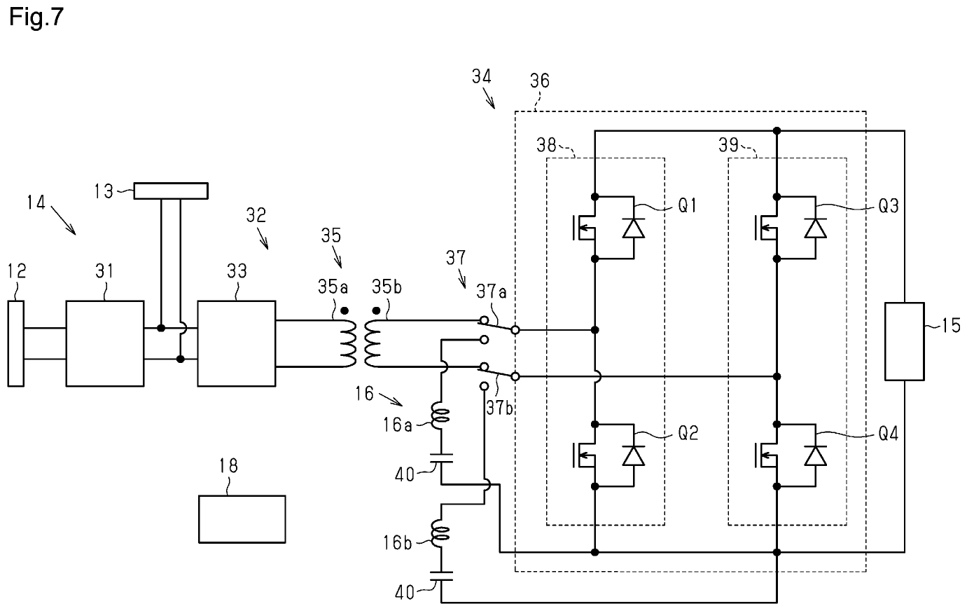

As shown in FIG. 7, multiple coils 16 may be provided. In this modification, two coils 16 are connected to the charger 14. Specifically, a first coil 16a and a second coil 16b are connected to the charger 14. The first switch 37a is selectively connected to the first end of the secondary winding 35b or a first end of the first coil 16a. Thus, the first end of the first coil 16a is connectable to the first switch 37a. A second end of the first coil 16a is connected to a connection node of the first lower arm switching element Q2 and the second lower arm switching element Q4, that is, the second end of the battery 15. The second switch 37b is selectively connected to the second end of the secondary winding 35b or a first end of the second coil 16b. Thus, the first end of the second coil 16b is connectable to the second switch 37b. A second end of the second coil 16b is connected to a connection node of the first lower arm switching element Q2 and the second lower arm switching element Q4, that is, the second end of the battery 15. When the first switch 37a is connected to the first coil 16a, the controller 18 controls induction heating with the first coil 16a by controlling the switching elements of the charger 14. When the second switch 37b is connected to the second coil 16b, the controller 18 controls induction heating with the second coil 16b by controlling the switching elements of the charger 14.

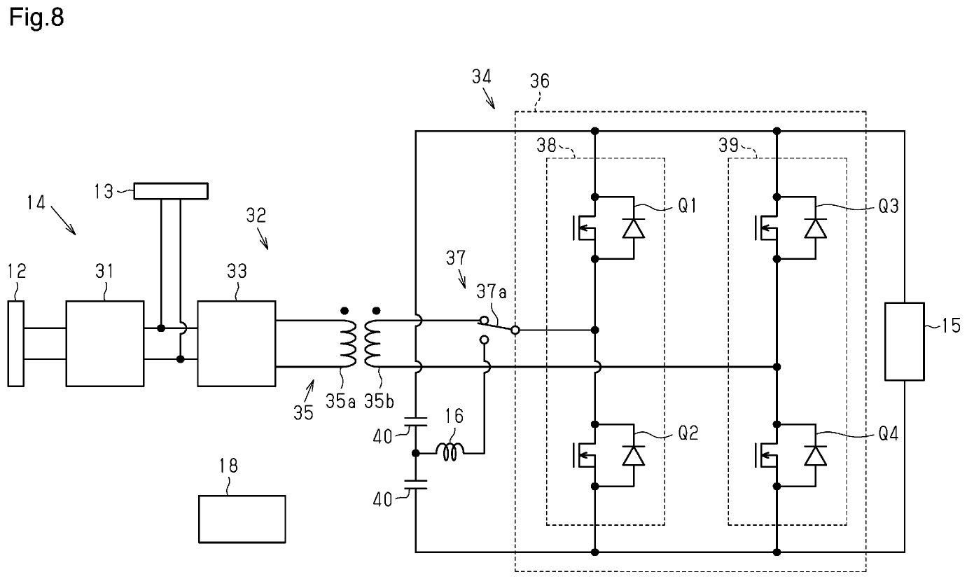

As shown in FIG. 8, the output switching unit 37 may be formed by a single switch. For example, in the same manner as the modification shown in FIG. 6, the output switching unit 37 may only include the first switch 37a. The first switch 37a is selectively connected to the first end of the secondary winding 35b or the first end of the coil 16. Thus, the first end of the coil 16 is connectable to the first switch 37a. The second end of the coil 16 is connected to a connection node of the first upper arm switching element Q1 and the second upper arm switching element Q3 and a connection node of the first lower arm switching element Q2 and the second lower arm switching element Q4. That is, the second end of the coil 16 is connected to the first end of the battery 15 and the second end of the battery 15. Specifically, the second end of the coil 16 is connected to the first end of the battery 15 and the second end of the battery 15 through the capacitors 40. When the first switch 37a is connected to the coil 16, the controller 18 controls induction heating with the coil 16 by controlling the switching elements of the charger 14.

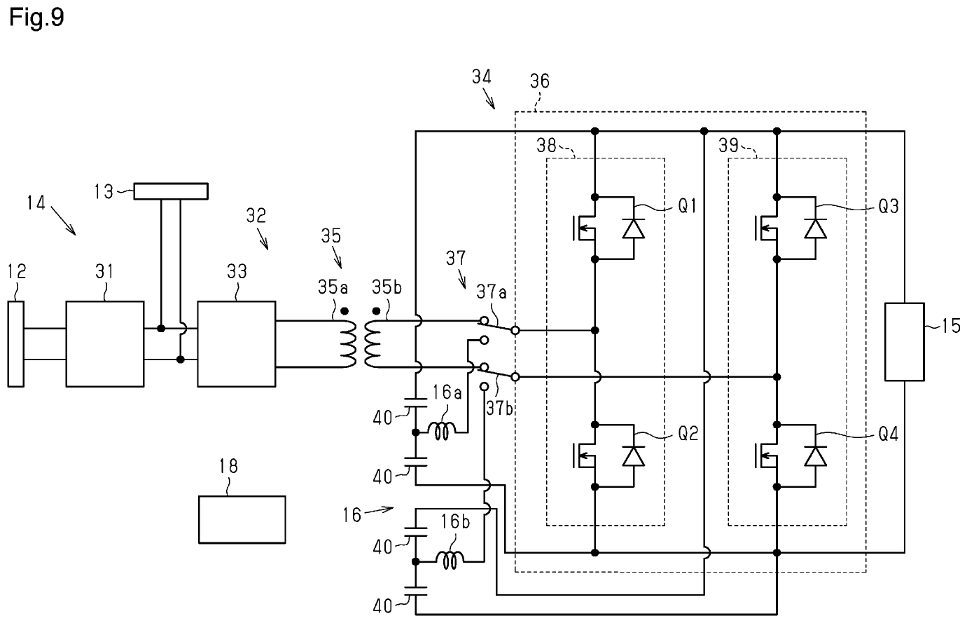

As shown in FIG. 9, multiple coils 16 may be provided. In this modification, in the same manner as the modification shown in FIG. 7, two coils 16 are connected to the charger 14. Specifically, the first coil 16a and the second coil 16b are connected to the charger 14. The first switch 37a is selectively connected to the first end of the secondary winding 35b or the first end of the first coil 16a. Thus, the first end of the first coil 16a is connectable to the first switch 37a. The second end of the first coil 16a is connected to a connection node of the first upper arm switching element Q1 and the second upper arm switching element Q3 and a connection node of the first lower arm switching element Q2 and the second lower arm switching element Q4. That is, the second end of the first coil 16a is connected to the first end of the battery 15 and the second end of the battery 15. Specifically, the second end of the first coil 16a is connected to the first end of the battery 15 and the second end of the battery 15 through the capacitors 40. The second switch 37b is selectively connected to the second end of the secondary winding 35b or the first end of the second coil 16b. Thus, the first end of the second coil 16b is connectable to the second switch 37b. The second end of the second coil 16b is connected to a connection node of the first upper arm switching element Q1 and the second upper arm switching element Q3 and a connection node of the first lower arm switching element Q2 and the second lower arm switching element Q4. That is, the second end of the second coil 16b is connected to the first end of the battery 15 and the second end of the battery 15. Specifically, the second end of the second coil 16b is connected to the first end of the battery 15 and the second end of the battery 15 through the capacitors 40. When the first switch 37a is connected to the first coil 16a, the controller 18 controls induction heating with the first coil 16a by controlling the switching elements of the charger 14. When the second switch 37b is connected to the second coil 16b, the controller 18 controls induction heating with the second coil 16b by controlling the switching elements of the charger 14.

The metal body 17 may be part of the configuration of the battery 15. The metal body 17 may be, for example, a case of the battery 15. In this case, the coil 16 heats the case of the battery 15. Thus, the battery 15 is effectively heated.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A vehicle, comprising:
a battery;
a coil;
a metal body located at a position that is affected by a magnetic field generated in the coil;
a charger configured to convert alternating-current power supplied from outside the vehicle into direct-current power and supply the direct-current power to the battery; and
processing circuitry configured to control the charger, wherein
the charger is configured to receive supply of direct-current power from the battery, and
the processing circuitry is further configured to control the charger so that the charger modulates the direct-current power, which is supplied from the battery, over time and supplies the power to the coil.

2. The vehicle according to claim 1, further comprising a fluid pipe through which fluid circulates, wherein
the fluid pipe is configured so that the fluid exchanges heat with the battery, and
the metal body is arranged to be in contact with the fluid.

3. The vehicle according to claim 2, wherein the metal body is arranged inside the fluid pipe.

4. The vehicle according to claim 2, wherein the fluid pipe is configured so that the fluid exchanges heat with the charger.

5. A method for controlling a vehicle, the vehicle including a battery, a coil, a metal body located at a position that is affected by a magnetic field generated in the coil, and a charger configured to convert alternating-current power supplied from outside the vehicle into direct-current power and supply the direct-current power to the battery,
the method comprising:
causing the charger to receive supply of direct-current power from the battery; and
causing the charger to modulate the direct-current power, which is supplied from the battery, over time and supply the power to the coil.
